(19) United States
(12) Patent Application Publication
(10) Pub. No.: US 2017/0277815 A1
(43) Pub. Date: Sep. 28, 2017

(54) GRANULAR RIVER ATTRIBUTES AND PREDICTIONS USING ACOUSTIC DOPPLER CURRENT PROFILER DATA FROM RIVER FLOATS

(71) Applicant: River Analyzer Inc. d/b/a Fresh Water Map, Bigfork, MT (US)

(72) Inventor: Mark Lorang, Bigfork, MT (US)

(21) Appl. No.: 15/462,715

(22) Filed: Mar. 17, 2017

Related U.S. Application Data
(60) Provisional application No. 62/312,378, filed on Mar. 23, 2016.

(51) Int. Cl. G06F 17/50; G01S 17/02; G01F 1/74; G01S 17/89

(52) U.S. Cl. CPC G06F 17/5009; G01S 17/89; G01S 17/023; G01F 1/74

(57) ABSTRACT

Acoustic Doppler current Profile (ADP) data may be collected by floating vessels down a section of a river. The ADP data may be merged with LIDAR data or other image data. The data may be processed to determine river attributes, such as flow velocity for a specific river level (flow volume). River attributes may also include depth, water clarity, temperature, and/or other river attributes. Capture of ADP data at different river levels may be interpolated between measures to estimate river attributes at multiple river levels that are different from the river levels associated with the collected ADP data. The processed data may be used to assess drift of particles/objects through a section of the river and/or identify conforming habitat in the section of the river based at least in part on parameters of the habitat, among other possible uses of the processed data.

### CROSS-REFERENCE TO RELATED APPLICATION

This application claims priority to U.S. Provisional Patent Application No. 62/312,378 filed Mar. 23, 2016 and entitled “A System and Method for the Assessment of River Attributes” which is herein incorporated by reference in its entirety.

### BACKGROUND

Rivers, worldwide, are managed through the use of data gathered at single point gauging stations. River gauging stations are used to estimate the volume of water flow referred to as discharge across a river transect at a fixed location. However, river gauging stations and flow models that rely solely on transect data do not provide sufficient information to adequately manage the supply and sustainability of freshwater represented by the flow of water in our rivers.

Attributes of the river (channel, depth, morphology, flow variance from fast to slow regions, water gains and losses and water temperature, clarity etc.) are all estimated between the river gauging stations using computation flow hydraulic modeling. Changes to river flow occur naturally due to the input of water from precipitation, snow melt and groundwater recharge to and from the river, especially in the floodplain reaches of rivers. The vast majority of rivers in the world have regulated flow regimes through dam operations, water extraction and diversion activities. The impacts to the river systems simply cannot be adequately captured by modeling alone. Human controls to river flow come from three principle means of control: 1) storage in reservoirs (e.g., regulated-lakes and reservoirs) and coupled with controlled release by dams 2) irrigation with drawl of water from diversions located in reservoirs and in-stream diversions (weirs which are partial dams across a river used to divert flow to an irrigation canal), and 3) levees and bank stabilization efforts that keep flow channelized rather than allowing water to spread out onto floodplains during high discharge events. These activities impact a river yet none of those impacts are measured by current techniques.

A gauging station includes a water level recorder that records water depth or stage in real-time. A cross-sectional survey transect line of the river at the location of the gauging station is measured, from a boat powered on its own or tethered from a line (e.g., a cable, etc.) or by wading where shallow enough, recording the area of the river and the flow velocity in sections across the transect line. Discharge of water past the transect line (Area×velocity=cubic meters or cubic feet per second) is the quantity that is ultimately determined relative to a stage height (water depth at a fixed location near the transect bank). Discharge versus stage height is repeatedly measured from low flow conditions to flood flow (if possible, often flood flow velocities are too high to allow a transect survey to be conducted) resulting in the development of a discharge versus stage relationship. Once that relationship has been developed, then measuring and recording stage height with a staff or pressure sensor is all that is required to estimate the discharge of water flowing past the gauging station. The only problem that develops is if the bottom topography of the river bed changes in some way (deepen by erosional scour or made more shallow by sediment deposition) thereby changing the transect area for any given actual discharge which changes the discharge versus stage relationship. Hence, all gauging stations need to be constantly calibrated by adjusting the discharge versus stage relationship as required.

The main piece of equipment that is used to measure discharge at a gauging station or any location in the river is called an Acoustic Doppler current Profiler (ADP), which measures the current velocity and depth as well as other attributes of a river flow. An ADP uses sound emitted from a transducer head and the return signals measured by a receiver to estimate how deep the water is and how fast the water is flowing. These instruments are deployed with the sound directed towards the bottom of the river, using multiple transducer/receivers (typically 3 to 9 transducers). A strong signal is returned from the bottom providing a measure of depth and return signals also are reflected to the receivers from particles suspended in the water column that are being carried with the flow of the water. Those signals return to the ADP head with a shift in frequency called a “Doppler Shift” which has a linear relationship with flow velocity. By sampling multiple transducer beams over many different time intervals, an estimate of flow velocity and direction is obtained across discrete bin intervals of depth (e.g. 10 cm to meters depending on total water depth and the instrument being used) which results in a 3D measure of flow vectors.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment used to collect and process data obtained from a river using Acoustic Doppler current Profiler (ADP) data and imagery data.

FIG. 2 is a block diagram of an illustrative computing architecture to perform capture of data and/or processing of the data in accordance with the disclosure.

FIG. 3 is a schematic diagram of an illustrative data collection plan including multiple float paths used to obtain ADP measurements along a section of a river.

FIG. 4 is a flow diagram of an illustrative process to collect ADP data during a float of a section of a river.

FIG. 5 is a schematic diagram showing an illustrative visualization of ADP data to show attributes of a section of a river.

FIG. 6 is a schematic diagram showing an illustrative visualization of ADP data and other image and/or LIDAR data to show attributes of a section of a river.

FIG. 7 shows an illustrative interface showing river attributes such as flow rate and/or habitat information for a section of a river.

FIG. 8 is an illustrative graph showing water surface profiles for measurements of a river at different volumes of flow.

FIG. 9 is a flow diagram of an illustrative process to collect ADP data at different observed volumes of flow and create a river model to predict river attributes at other volumes of flow that were not observed.

FIG. 10 is a schematic diagram that shows illustrative drift paths of particles in a section of a river.

FIG. 11 is a flow diagram of an illustrative process to predict drift of a particle or object down a section of a river for a given volume of flow.

### DETAILED DESCRIPTION

This disclosure is directed to collecting Acoustic Doppler current Profile (ADP) data and processing the data, possibly along with other data such as LIDAR data and/or image data, to determine attributes at various points along a river section. In some embodiments, the processed data may be used to generate a model configured to predict attributes of the river, predict drift of particles/objects through the section of the river, and/or identify conforming habitat of aquatic species in the section of the river based at least in part on parameters of flow and water depth describing habitat, among other possible uses of the processed data.

Anyone who has rafted down a second or third class river will know that the flow velocity of water in a river is not the same along all sections of the river. When a river becomes narrow, the flow velocity through that narrow section is faster than through a wider section. Thus, the flow velocity changes along the river even if the flow volume (amount of water crossing a transect per period of time) remains constant when measured along these sections of the river. By measuring the downstream attributes of a river, including flow velocity at different flow volumes, this data may be useful to predict changes in the river given increases or reductions in flow volume, such as due to rainfall, drought, planned dam releases/discharges, irrigation usage, and/or other events.

Examples in accordance with the present disclosure may provide solutions for providing sufficient information about river attributes such as water depth and flow velocity, and other attributes like bed scour, water clarity, temperature etc., that may be of importance for analysis of the river between river gauging stations and over a range of flow volumes (i.e., discharge levels). The disclosed techniques of data collection, processing and analysis (also referred to as River Analyzer in some examples) can provide the information that may enable a more effective management of our rivers and thereby solve problems associated with the supply and sustainability of freshwater on a global scale.

The techniques and systems described herein may be implemented in several ways. Example implementations are provided below with reference to the following figures.

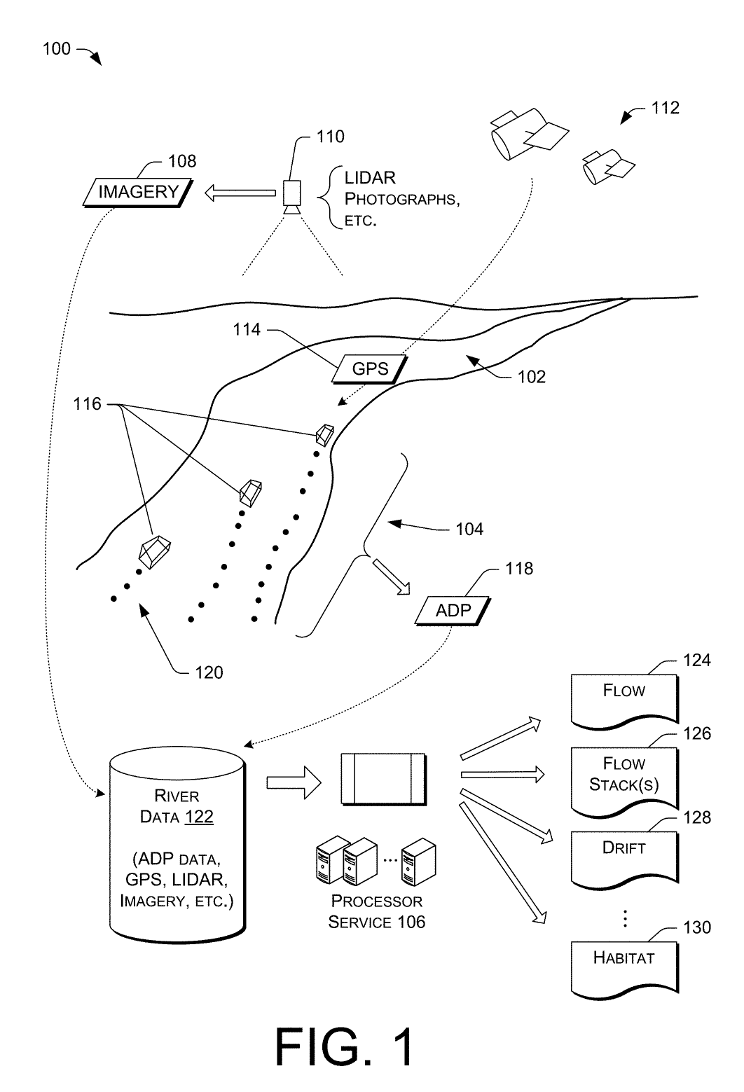

FIG. 1 is a schematic diagram of an illustrative environment 100 used to collect and process data obtained from a river using Acoustic Doppler current Profiler (ADP) data and imagery data. The environment 100 may include a river 102 or other body of moving water to be measured to determine flow characteristics and other river attributes. The river 102 may be divided into sections which may be measured, such as a section 104 of the river 102. The section may any length that is measurable using the techniques discussed below within a time period where the river conditions remain substantially the same, and are not impacted by added water (e.g., via rain, etc.), unusual loss of water (e.g., prolonged drought, irrigation drainage, etc.), and/or subject to other changes (e.g., seasonality, temperature, etc.).

In accordance with the present disclosure, examples of a system and method of analyzing hydro acoustic measurements of river attributes are described. In some examples, the hydrostatic measurements may be operatively combined with airborne and/or satellite data and resulting data may be analyzed and visualized via a processor service 106. The combination or fusion of this multi-dimensional data (e.g., local river data, satellite data, airborne data, etc.) may also be referred to herein as a processed data set.

A process may include collecting the imagery 108 via an imaging device 110 situated above the river 102. The imagery 108 may include LIDAR, photographs, infrared imagery, and/or other light or image data obtained from an aircraft, balloon, satellite, or other craft above the river 102. Satellites 112 may enable collection of Global Position System (GPS) data 114 by ADP collection devices 116.

Each ADP collection device 116, which may be configured on vessels, may float down a section of the river 102 to obtain ADP data 118 at locations 120 from time to time, such as at timed intervals, in response to distance traveled, and/or at other times (e.g., records a data file twice per second over the distance floated). The ADP data may be local river data, which may also be referred to as hydraulic data. The ADP collection devices 116 may obtain ADP data 118 (e.g., recorded data files) at known locations in the river 102 at a known river flow volume (i.e., discharge level). The ADP data 118 may contain information on the water depth and flow velocity, as well as other attributes like backscatter intensity which may provide information about the concentration of suspended matter in the water column, among other possible information. The ADP collection devices 116 may output the ADP data 118, which may include the GPS data 114.

As discussed above, a GPS may be co-located with each ADP collection device 116 so that the ADP data 118 gathered by the ADP collection device 116 is associated with a specific location on earth. This GPS data 114 may enable association of the ADP data 118 with the imagery data 108 (e.g., LIDAR data, photograph data, etc.). As an example, the imagery data 108 may include reflectance characteristics of the river. Each bin interval (specific data sample at a specific location of the locations 120) from the ADP data 118 may contain flow data to resolve a three-dimensional (3D) nature of the flow within each bin from a surface of the water toward the bottom of the river. The bin interval may be thought of as a portion or a slice of the water column for which data is being recorded at any given instance in time.

In some examples, multiple vessels may float down the river 102 in a coordinated fashion (roughly along sometimes parallel paths) to collect the ADP data 118 across the width of the river. In other examples, multiple passes with a single or several vessels may be used to collect the ADP data 118.

Because river channels and flow fields of a river may be complex, in some examples multiple data collection paths may be used as a data collection methodology to adequately cover the river 102. Rivers are naturally very complex and have varied bottom topography (bathymetry) and the spatial distribution of flow fields, which may result in water types that have common names to everyone from fisherman to fisheries biologist (riffles, rapids, runs, shallow shoreline, eddies etc.) that are arrayed along the river in repeatable sequences.

Because of this natural complexity in bathymetry and flow, computer models may not be able to accurately describe the real variance in the river between gauging stations, especially over long downstream distances. Because the bathymetry and spatial distribution of flow types remain relatively stable between flood events, rivers may be mapped with detail and improved accuracy using the systems and methods described herein. Rivers may be mapped during floods in accordance with the examples herein such that the dynamic processes that actively shape and change a river may be more accurately measured, which may enable analysis of river attributes over many discharge levels and over great downstream distances, which may enable determination of flow and river attributes as that can change over time. Thus, the process disclosed herein can not only capture the 3D nature of the river 102 over a long distance (e.g., over many miles), but the process can also capture or predict the variable nature of the river over time.

The imagery data 108 and the ADP data 118, including the GPS data 114 may be stored as river data 122 in a data store, which may be remotely located from the ADP collection devices 116. The river data 112 may be processed by the processor service 106, as discussed in more detail below, to generate one or more possible outputs such as flow data 124, stacked flow data 126 to predict river flow at non-measured conditions, drift data 128 to determine and predict drift path and flow velocity along the path of a particle/object in the river 102, and/or habitat data 130 to identify locations suitable and/or not suitable for a habitat having certain parameters (e.g., flow velocity, temperature, depth, etc.).

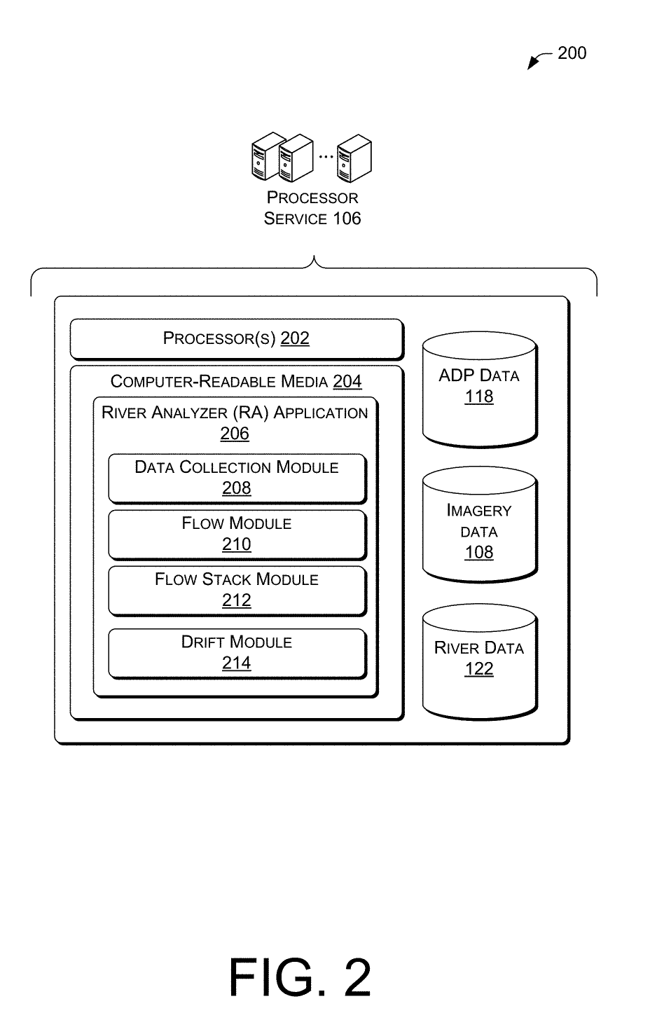

FIG. 2 is a block diagram of an illustrative computing architecture 200 to perform capture of data and/or processing of the data in accordance with the disclosure. The computing architecture 200 may be representative of the processors service 106. The computing architecture 200 may be implemented in a distributed or non-distributed computing environment. In some embodiments, at least some of the computing architecture may be implemented on or within an ADP collection device 116, for example.

The computing architecture 200 may include one or more processors 202 and one or more computer readable media 204 that stores various modules, applications, programs, or other data. The computer-readable media 204 may include instructions that, when executed by the one or more processors 202, cause the processors to perform the operations described herein for the service 104.

Embodiments may be provided as a computer program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be by an Internet download.

In some embodiments, the computer-readable media 204 may store a river analyzer application 206, which may include various modules such as a data collection module 208, a flow module 210, a flow stack module 212, and a drift module 214, which are described in turn. The modules may be stored together or in a distributed arrangement.

The data collection module 208 may control one or more of the ADP collection devices 116 to collect the ADP data 118. In some embodiments, the data collection module 208 may analyze collected data to determine whether additional runs (floats) down a section of a river are advised to collect additional data, such as when a river section includes complexity such as separation paths, a large width, rapids, and/or other features that may prompt additional data collection by one or more passes (floats) through the section or specific area. The data collection module 118 may pair the GPS data 114 with the ADP data 118 such that each bin includes location information. This information may be used to create a transect at a point along the river to calculate flow volume, among other possible uses. The data collection module 208 may facilitate storage of the ADP data 118, such as at a location remote from the ADP collection devices 116. In some embodiments, the data collection module 208 may be informed by at least some of the imagery data 108, which may include LIDAR data and/or photographic imagery of the river. For example, the imagery data 108 may indicate a location of banks of the river for a specific river condition (e.g., for a flow volume). The location of the banks of the river may inform where to locate and space apart the float paths used by the ADP collection devices 116. The imagery data 108 and the ADP data 118 may be stored as the river data 122 for use by other modules and for other processing as discussed below and herein.

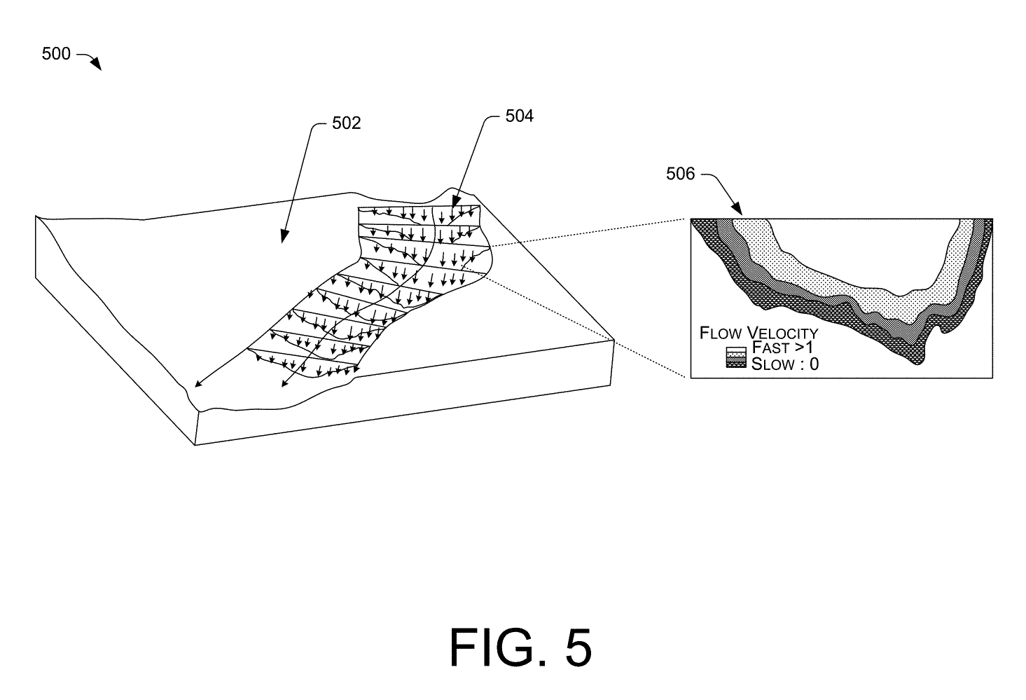

The flow module 210 may analyze the river data to output observed attributes of a section of the river. In some embodiments, the flow module 210 may create extrapolated data, such as to extrapolate data for a location between two observed locations associated with observed data. The flow module 210 may use the observed data and the extrapolated data, which may be stored in the river data 122, to create outputs for a section of the river. The outputs may include attributes of the river, such as channel size, depth, morphology, flow variance from fast to slow regions, water gains and losses, water temperature, clarity, types, drift, and/or other attributes that are captured directly from the ADP collection device 116 or derived therefrom. The flow module 120 may create a two-dimensional (2D) or 3D model of the section of the river, which may visually show at least some of the river attributes, such as depth, flow velocity, and/or other attributes, possibly using color coding or other imagery, such as imagery shown in FIGS. 5-7. In some embodiments, the flow module 210 may support a user interface that allows users to interact with data output by the flow module 210 to explore the attributes of a section of a river, for example.

The flow stack module 212 may enable creation of a model to predict river attributes at flow volumes that may or may not include observed data. For example, the flow stack module 212 may include ADP data for at least three different flow volumes, such as: 1) a low flow volume that includes enough water flow to support data collection by floating the ADP collection device 116 down a section of the river, 2) a high volume such as a flood condition of the river, and 3) an intermediate flow volume between the low volume and the high volume. The flow stack module 212 may analyze this data, using regression analysis techniques or other similar statistical interpolation techniques, to create a model that predicts river attributes at different flow volumes between the low flow volume and the high flow volume. To determine the flow volume, the flow stack module 212 may associate LIDAR data of a surface level of the river with the data, and then may measure a current surface level of the river as an input to the model. The surface level of the river may, therefore, be associated with a flow volume of the river. The resulting model may include some or all the data discussed above in the description of the flow module 208. In some embodiments, the flow module 208 may be used with the flow stack module 212 to enable output of interfaces to provide flow information at a specific river condition (e.g., flow volume.) The flow stack module 212 may provide an interface to enable exploration and/or comparison of a river segment at different flow volumes, such as to predict or monitor changes to the river, habitat, and/or other attributes in response to weather patterns (e.g., rain, drought, etc.), planned or unplanned manmade discharge from a dam or other water source, and/or other changes (added irrigation drainage, etc.).

The drift module 214 may determine drift of a particle or object through a river. The drift module 214 may generate a model of drift movement from the float paths of the ADP collection devices 116 and from observed movement of particles suspended in the water, which may move up/down, left/right, and/or in other directions in different parts of the river. This information may be stored in the river data 122 and analyzed by the drift module 214 to predict drift of particles having known attributes, such as buoyancy or settling velocities.

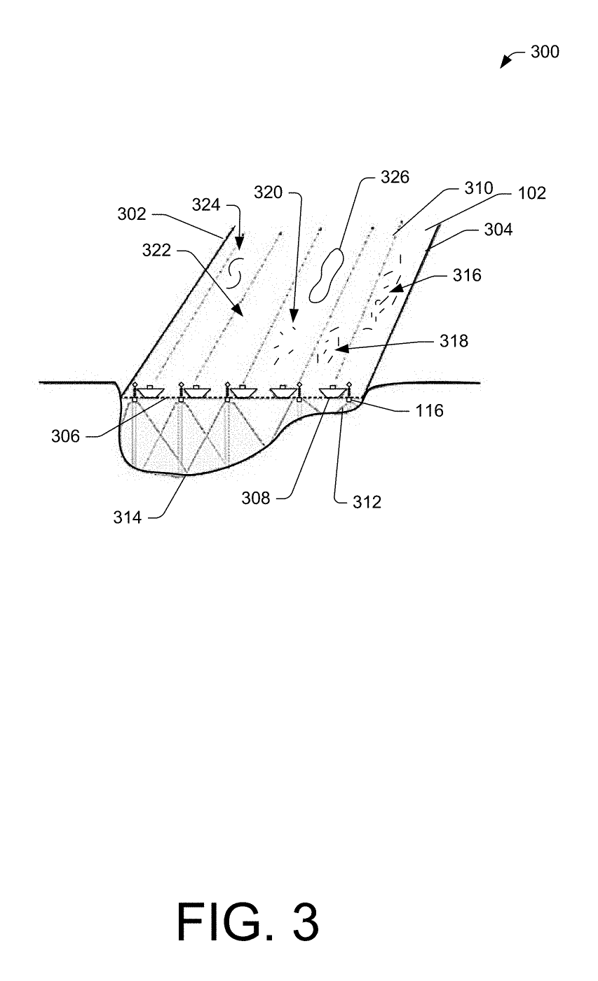

FIG. 3 is a schematic diagram of an illustrative data collection plan 300 including multiple float paths used to obtain ADP measurements along a section of the river 102. As shown, the river 102 may include a first river bank 302 and a second river bank 304, as well as a river surface 306, which may be determined using the imagery data collected by LIDAR, photographs, and/or other image or light techniques.

To collect data, a vessel 308 (or multiple vessels) may float down a path 310. Multiple paths may be included in a section of the river 102. The path may be determined by characteristics of the river. In some embodiments, the vessels may attempt to maintain a separation distance from one another. The separation distance may be based at least in part on a width of the river 102 at a given transect (distance between first river bank 302 and second river bank 304). Thus, the vessels may be powered and may be able to navigate along a path. In some embodiments, the vessels may drift and the path may be defined by flow of the river, such as when the vessels are not powered. Each vessel may include the ADP collection device 116 to collect a bin 312 of ADP data, or ensemble of bins which is shown as a column of bins within the “wedge” shaped cone of sound representing the area of sound emanating from the multiple array of directed transducers below the ADP collection device 116 and toward a bottom 331412 of the river 102. In some embodiments, the sonification area may overlap to create complete coverage of the bottom of the river. However, this may not be necessary for simple portions of a river, such as portions with a smooth bottom or other predictable attributes. However, in more complex portions of the river, additional data collection may be warranted, and may be collected by additional passes or floats down a same section of the river 102. For example, the river may include features such as a shallow portion 316, a low turbulent run 318 with small rapids, a medium turbulent run 320 with mild rapids (e.g., class 1, class 2, etc.), a clean run portion 322, an eddy 324, an island or debris 326, and/or other attributes. In some embodiments, the features may influence a path or a repeat data collection for the river to capture data, such as for complex portions of the river having at least some of the features 316-326.

In accordance with one example, the data collection process may involve a roughly parallel Lagrangian (downstream with the flow) float of ADP-equipped vessels. If a vessel encounters a complex flow feature (e.g., a turbulent flow field), the vessel may be directed to return upstream of the complex flow feature and collect additional localized data. This process may be repeated until sufficient localized (e.g., high density data) has been recorded such that the complex flow feature is adequately represented in the collected data. The vessel may then continue along the Lagrangian path. In some examples, multiple parallel travelling vessels may be directed to collect localized (e.g., high density) data as described before continuing downstream of a flow feature. In some examples, one or more vessels may encounter a flow separation feature (e.g., an island, debris, etc.). A vessel affected by a flow separation feature may be directed to follow the preplanned Lagrangian path to a convergence downstream of the flow separation feature and wait a period of time. In some examples, the vessel may be directed to return upstream to or just before the flow separation point and the data collection step associated with the flow separation feature may be repeated. In this manner higher density data may be obtained for this flow feature. In some examples, the vessels may be operated by a river technician locally (e.g., on the vessel) or remotely (e.g., via a remote control system of the vessel). In some examples, the vessels may be semi- or fully autonomous and may be pre-programmed to follow a specified path for the data collection process and/or to invoke a particular separation distance from adjacent vessels based at least in part on factors such as a width of the river at a given point. When the data has been collected (e.g., upon the completion of the Lagrangian path or multiple loops or passes of the Lagrangian path including any localized loops as may be desired to obtain higher density data), or at other times, the recorded data may be transmitted to the river data 122.

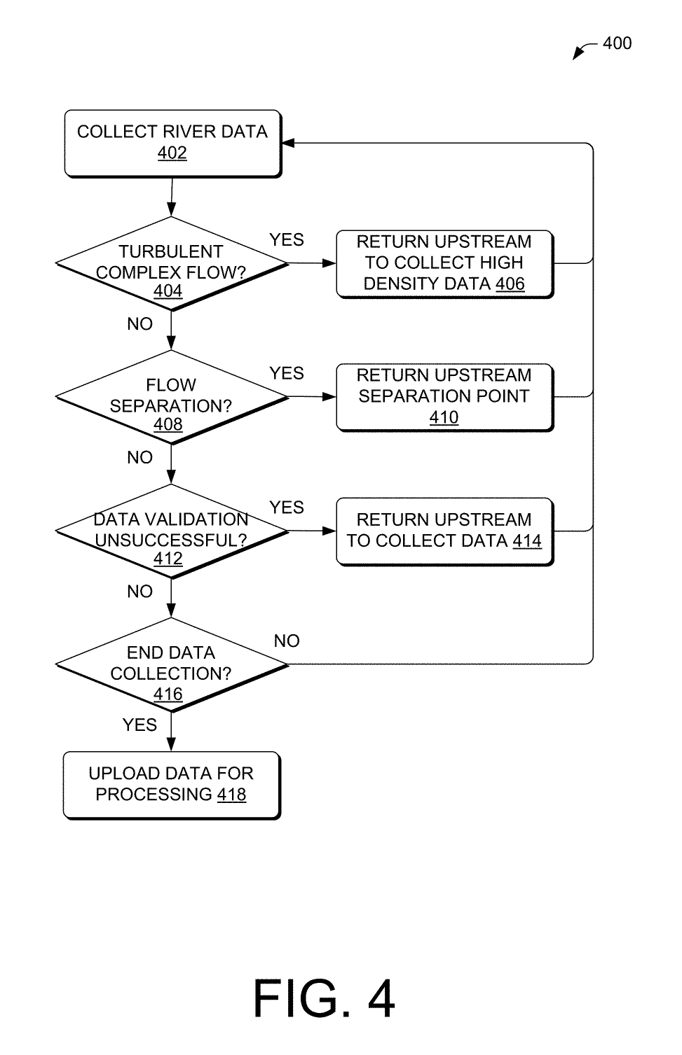

FIG. 4 is a flow diagram of an illustrative process 400 to collect ADP data during a float of a section of a river. The process 400 is illustrated as a collection of blocks in a logical flow graph, which represent a sequence of operations that can be implemented in hardware, software, or a combination thereof, possibly in the field while gathering data or just after gathering data. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. The process 400 is described with reference to the environment 100 and the computing architecture 200. Of course, the process 400 may be performed in other similar and/or different environments.

At 402, the data collection module 208 may cause the vessels and ADP collection devices 116 to collect the ADP data 118 along float paths of a section of a river. In some embodiments, the collected ADP data may be pre-processed, for example by a quality control or quality assurance tool such as to filter out noise or remove data artifacts. Data outliers in any of the input data sets may be flagged and the image data (e.g., satellite, LIDAR) may be assigned file locations.

At 404, a float path may be analyzed to determine whether the float path includes a turbulent complex flow. The analysis may be based at least in part on movement or operation of the vessel (e.g., accelerometer data, GPS data, etc.), analysis of the ADP data collected from the float path, inspection of the imagery data 108, human input, and/or from other information. When the float path is determined to include turbulent complex flow (following the “yes” route from the decision operation 404), such as based at least in part on flow velocity or change in flow velocity exceeding a threshold and/or other attributes having values outside of measurement ranges, then the process 400 may advance to an operation 406 to cause the vessel and ADP collection device 116 to return upstream to collect high density data. Following the operation 406, the process 400 may advance to the operation 402 to collect the data and continue processing. When the float path does not include turbulent complex flow (following the “no” route from the decision operation 404), then the process 400 may advance to a decision operation 408.

At 408, a float path may be analyzed to determine whether the river includes a separation caused by a land mass (island, etc.), by debris, by a manmade structure, etc. The analysis may be based at least in part on inspection of the imagery data 108, human input, and/or from other information. When the river includes a separation (following the “yes” route from the decision operation 408), then the process 400 may advance to an operation 410 to cause the vessel and ADP collection device 116 to return upstream of the separation to collect data for a different path through the separation (e.g., a path not previously taken, etc.). Following the operation 410, the process 400 may advance to the operation 402 to collect the data and continue processing. When the river does not include a separation (following the “no” route from the decision operation 408), then the process 400 may advance to a decision operation 412.

At 412, data obtained from a float path may be analyzed to determine if the data is validated. The analysis may include comparing information derived from the ADP data collected from the float path to other information, such as predicted model outputs, data derived from imagery data, and/or other information The purpose of the validation is to determine whether to correct or recapture data for a section of a river as soon as possible while a condition of the river (e.g., flow volume) remains fairly constant, rather than discovering a problem with data (e.g., incorrect data, missing data, etc.) at a later time that does not accommodate ease of capture of additional data at the river condition. When the data validation is unsuccessful (following the “yes” route from the decision operation 412), then the process 400 may advance to an operation 414 to cause the vessel and ADP collection device 116 to return upstream to collect additional data. In some embodiments, the operation 414 may also include inspection of devices for damage or proper operation. For example, an ADP collection device may not collect proper information if entangled in debris or otherwise interfered with during operation. Following the operation 414, the process 400 may advance to the operation 402 to collect the data and continue processing. When the data validation is successful (following the “no” route from the decision operation 412), then the process 400 may advance to a decision operation 416.

At 416, the data collection module 208 may determine whether to end data collection. When the data collection is to continue (following the “no” route from the decision operation 416), then the process 400 may advance to the operation 402 to collect additional data and continue processing. When the data collection is to terminate (following the “yes” route from the decision operation 416), then the process 400 may advance to an operation 418.

At 418, the data collection module 208 may update the collected ADP data to the river data 122 for processing. The upload may be performed as a batch process or by streaming of data. The upload may be performed wirelessly, such as via a mobile telephone network or via other wireless networks. In some embodiments, the data may be uploaded via a wired link, such as by transferring data from local storage to remote storage.

FIG. 5 is a schematic diagram showing an illustrative visualization 500 of ADP data to show attributes of a section of a river. The visualization may be generated using inputs received from a user interface. The visualization 500 may combine or otherwise leverage the ADP data 118 and the imagery data 108, which may include LIDAR data, photography, and/or other light or image information to enhance the ADP data. For example, by combining multiple data sources, the visualization 500 may be generated that includes a topography 502 of landscape obtained via the LIDAR or imagery data 108 and bathymetry and river attributes 504 obtained and/or determined from the ADP data 118. The river attributes may be shown as transects 506 or cross-sectional slices, which may be color coded to show different attributes of the river, such as flow velocity, water clarity, temperature, and/or other attributes.

In various embodiments at least some processing and/or analysis may be performed via inputs received from a user interface. For example, the processor service 106. may be operatively associated with a user interface which enables the user to set analysis parameters and/or provide locators to the processor service 106 for retrieving the relevant data sets. The user interface may be configured to display one or more user interface elements for receiving user inputs, such as input for setting the size and path of the data integration window and/or for displaying information in real-time to the user during the analysis process, such as visual representations of collected data sets, data sets that are being fused, and of the progress of the integration. In some examples the size of the integration window may be set responsive to user inputs (e.g., responsive to specifying a width and length of the data integration box). In some examples, the size of the integration window may be automatically set by the system based at least in part on certain parameters of the river and/or parameters associated with the collected data (e.g., dimensions of a water column recorded an ADP, vessel speed during data collection, etc.). The user interface may be configured to receive inputs for setting the path of data integration box, for example by providing a user interface element which enables the user to define a centerline of the river. However, the centerline may be determined without user input, such as by analysis of the imagery and/or LIDAR data that indicates location of the river banks.

Once the centerline is determined and the data integration window size is set, the processor service 106 may begin to process the data by “sliding down” a selected section of the river at a pre-set distance (e.g., one or several meters) at a time, retrieving data from the various sources (e.g., the ADP data 118, the imagery data 108, etc.). As a data integration window moves along the path, the data from the multiple sets of data (e.g., ADP data, satellite, LIDAR) is compiled and/or combined and plots of the river transects based at least in part on the fused data may be generated and possibly displayed in a user interface. In some examples, multiple plots may be displayed, e.g., for the center axis of the data integration window and as well as where the window is located along the river and the nature of the data fusion between ADP depth and Lidar data. An example of imagery generated by the processor service 106 is shown in FIG. 5.

Combined imagery and ADP data may be an important tool to represent flow between river transects. Conventional models typically require data be collected as transects across a river and then within the model two assumptions are made; 1) the river channel is the same between transect locations and 2) the river channel planform and bathymetry does not change. However, both of these assumptions are known to be false and they remain as real limitations to accurate representations of the actual river. The river analyzer application 206 may improve modeling efforts and in many cases replace them because RA using actual empirical data covering the expanse of the river and then fuses that measured channel bathymetry to the 3D flow field and the floodplain topography.

The river analyzer application 206 may visualize and assess the real complexity in river flow and bathymetry by creating block diagrams. This output alone may be valuable to many users from fisherman to dam operators.

In some embodiments, the river analyzer application 206 may be configured to include one or more application tools that may enable the user to access the processed data, visualize the processed data to create the visualization 500 and/or other visualizations, and/or perform simulation and analysis using the processed data to obtain useful information about attributes of the river and/or river ecosystem. For example, a slicer tool may enable the user to generate the transacts 506, cross-sectional slices, of a river such as to examine the 3D complexity of flow. Cross-sectional data obtained from the river analyzer application 206 may include not only cross-sectional data but also the water surface slope between such cross-sections. This cross-sectional data from river analyzer application 206 can also be exported to conventional flow models to improve results obtained from such conventional flow models.

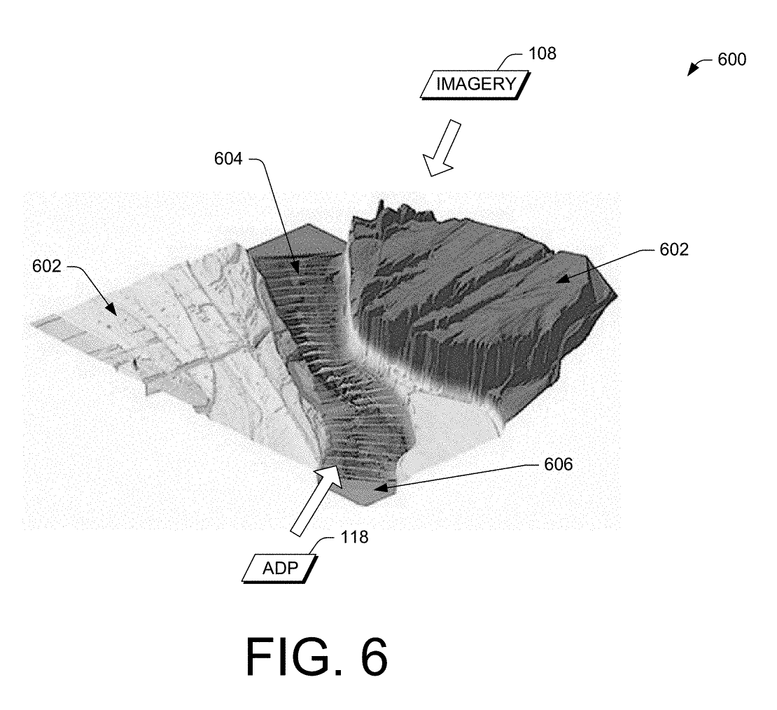

FIG. 6 is a schematic diagram showing an illustrative visualization 600 of the ADP data 118 and the imagery data 108 (e.g., images and/or LIDAR data) to show attributes of a section of a river. The visualization 600 is a 3D visualization that may include land topography 602, river attributes 604, and other visual information. The visualization 600 may be color coded to show flow information, such as differences in flow velocity in the river. LIDAR data may be used to determine both the floodplain topography and a surface level 606 of the river, which may be associated with the river attributes. The river analyzer application 206 may visualize and assess the real complexity in river flow and bathymetry as actually connected to floodplain topography which is vital to flood inundation modeling as well as river access for fish. As discussed below and elsewhere in this document, the river level may be an input into a model to predict different river attributes for the given river level (e.g., river condition), which may be associated with flow volume, for example. In some embodiments, the visualization 600 may be generated in response to inputs received from a user interface that allows a user to input parameters, such as river attributes for visual analysis. As an example, the river attributes 604 shown in the visualization 600 may be coded based at least in part on specified parameters, such as flow rates greater than a threshold. This may be useful when analyzing a river as a habitat for spawning fish, for erosion, flooding and/or for other factors, for example.

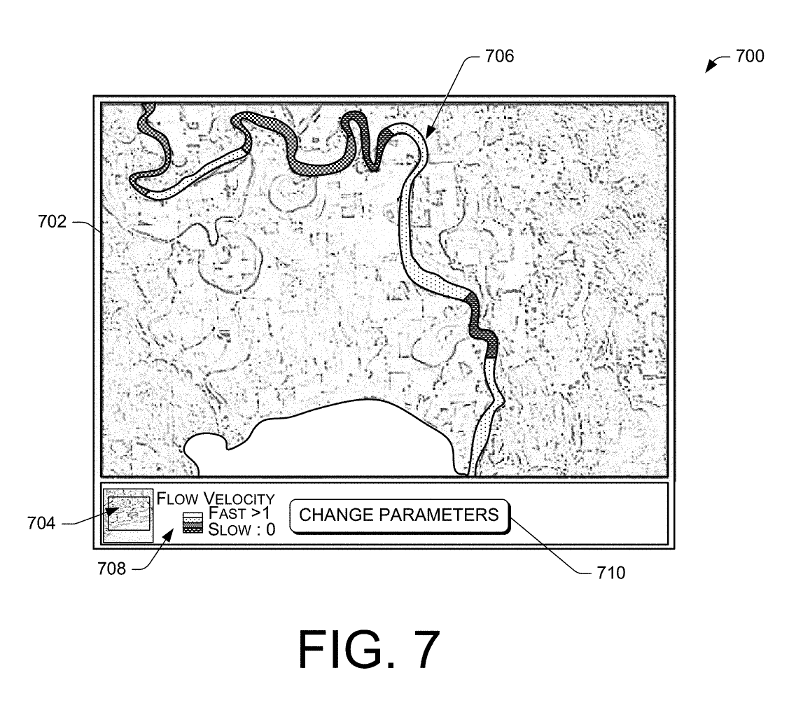

FIG. 7 shows an illustrative interface 700 showing river attributes such as flow rate and/or habitat information for a section of a river. The interface 700 may show a map 702 of a region of land that includes a river 704. The map 702 may be a subset of a larger region 704, and may facilitate user interaction such as by zooming in/out, panning, and other common interface controls. The river 704 may be depicted in a 2D view, and may be color coded or otherwise may visually depict select river attributes. The depicted river attributers may be shown via an attribute key 708. An example river attribute is flow velocity, however, other river attributes may be selectively included, such as water clarity, depth, width, flow type, temperature, and/or other attributes. Attributes may be selected/deselected via a control 710. By interacting with the interface 700, a researcher may change river attributes to inspect certain details about a river at an observed flow volume, or as discussed in more detail below, and predicted flow volumes using outputs from the flow stack module 212. The researcher may query for specific habitats based at least in part on river attributes parameters (e.g., flow velocity less than a threshold, depth greater than a threshold, etc.). Generally, the visualization shown in FIGS. 5-7 may be applied to outputs of the flow stack module 212, but may be generated in part on outputs from the flow module 210.

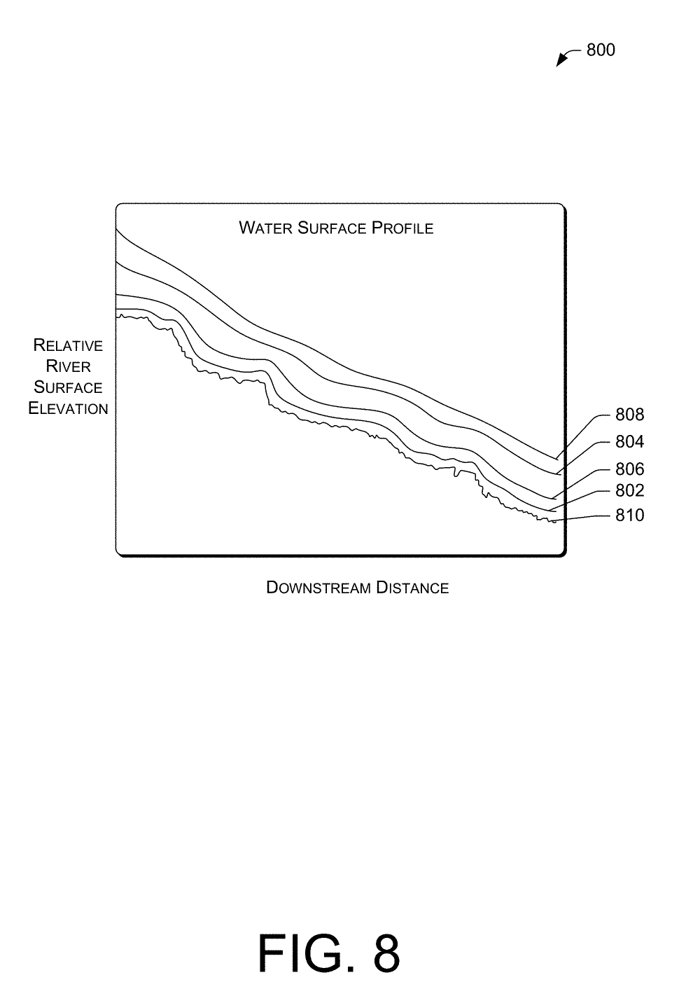

FIG. 8 is an illustrative graph 800 showing river levels (or water surface profiles) for measurements of a river at different flow volumes. The graph 800 includes a river elevation as a y-axis and a distance downstream as an x-axis.

The river levels may be obtained using LIDAR and/or physical measurements of a river, such as using ADP instrumentation that includes GPS receivers to measure an altitude of the ADP device with respect to the surface of the river. In some embodiments, three or more measurements of ADP data may be performed for a river, such as a first ADP data collection at a low flow volume associated with a first river level 802, a second ADP data collection at a high flow volume (e.g., near flood or at a flood volume) associated with a second river level 804, and a third ADP data collection at an intermediate flow volume associated with a third river level 806. The second river level 804 may be relatively smooth due to nearness or actual flooding of the river. Using this data, the flow stack module 212 may generate a model to predict river attributes at intermediate river levels between the first river level 802 and the second river level 804, such as using regression analysis tools.

Multiple flows at different discharge levels are processed in a same way and then stacked upon each other using the flow stack module 212. When rivers flood they tend to wash out or drown riffles and rapids resulting in a smoother water surface and less spatial complexity in flow. This makes it easier to collect data on one hand as most of the flow is a turbulent run but also more dangerous given the fast and deeper water but also drifting debris and submerged hazards like trees and root wads. The upside is that it is easy to obtain extremely accurate data at flow rates that are impossible to collect from vessels trying to transect the river. Hence the unique and novel methodology described herein may improve the discharge stage relationships for all gauging stations.

Until recently, LIDAR data does not penetrate water and even the newest LIDAR instruments can only penetrate clear water. Therefore, most of the available LIDAR data and new data supplied by providers of LIDAR data does not penetrate the water surface, and hence it, appears as a flat surface when plotted in 3D. A river level of dry riverbed or low river may be captured using LIDAR, shown as a fourth river level 810.

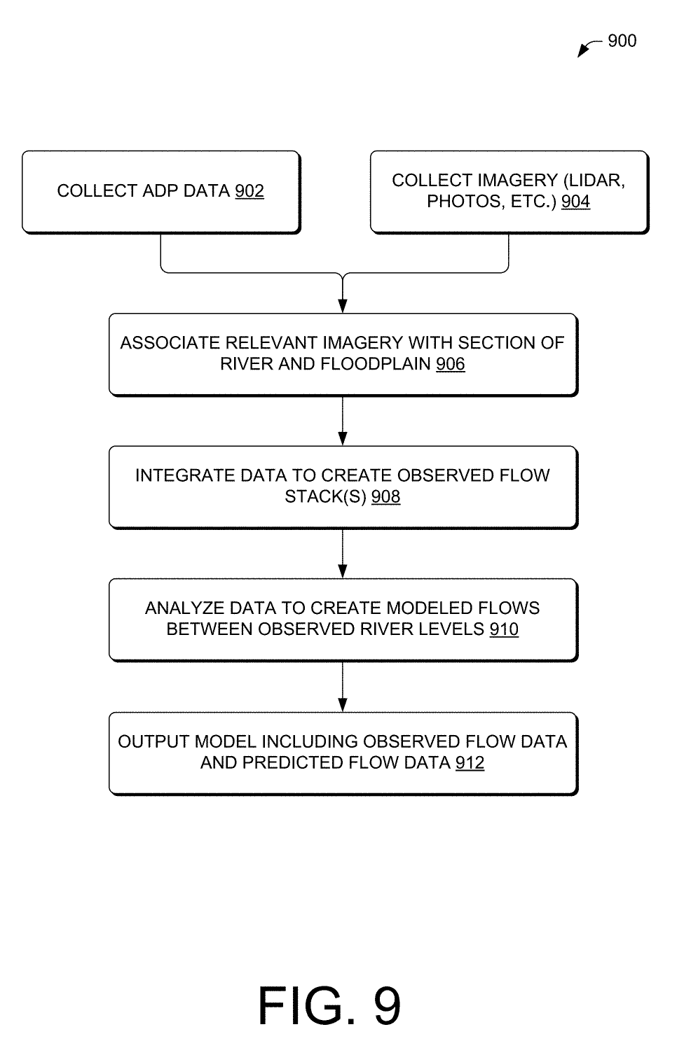

FIG. 9 is a flow diagram of an illustrative process 900 to collect ADP data at different observed volumes of flow and create a river model to predict river attributes at other volumes of flow that were not observed. The process 900 is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. The process 900 is described with reference to the environment 100 and the computing architecture 200. Of course, the process 900 may be performed in other similar and/or different environments.

At 902, ADP data may be collected at various known river levels associated with particular flow volumes. The ADP data may be collected at different times of year, after different types of events (e.g., rainstorms, snow melt, drought, planned manmade discharge release, prior or post irrigation usage).

At 904, imagery may be collected at times that correspond to the collection of the ADP data at the operation 904. The imagery may include LIDAR data, photography data, and/or other image or light information that may enhance the ADP data, such as by measuring a river level (via a surface level of water), determining or showing river banks, showing topography, showing visual river attributes (e.g., rapids, separation points, etc.), and by providing other complimentary information.

At 906, relevant imagery may be associated, integrated, and/or combined with corresponding ADP data for a section of a river and/or a floodplain. For example, the imagery data may be merged, fused or otherwise combined with ADP data to create data that includes land information (e.g., river banks, topography, etc.) and river attributes (e.g., flow velocity, depth, clarity, temperature, and/or other river attributes). In various embodiments, the imagery data and ADP data from a same time period are merged to enable proper alignment of features of the river and imagery data.

At 908, the flow stack module 212 may create modeled flow between observed data associated with different river levels. For example, as discussed above with reference to FIG. 8, multiple sets of ADP data may be used to create a model, possibly using regression analysis or similar techniques to predict river flow at different river levels than the observed river levels measured to obtain the ADP data.

At 910, the flow stack module 212 may output a model that includes the observed flow data from actual ADP data collection and predicted flow data, which leverages the observed data to predict flow at intermediate river levels as discussed above. This model may be used to generate, view, and interact with a river and river attributes associated with a river at a given river level, which may be an input to the model. Thus, the river level may be input as a parameter, which may be input via LIDAR data to model a current state of the river or a state as of when the LIDAR measurement occurred, or may be input via other means, such as via human input.

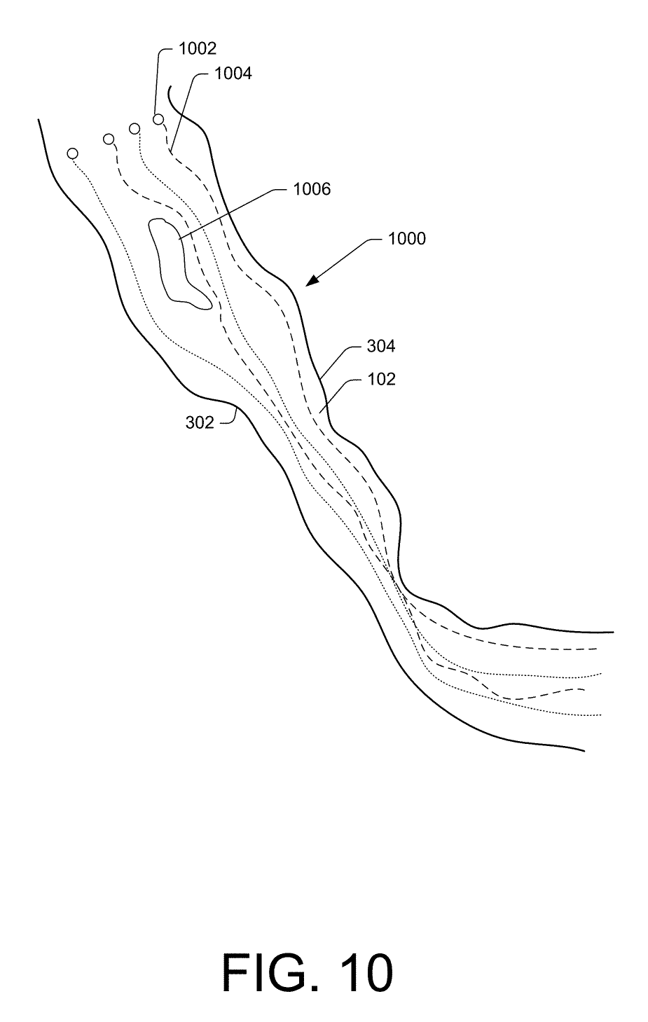

FIG. 10 is a schematic diagram that shows illustrative drift paths 1000 of particles (or objects) in a section of a river. For example, a particle 1002 may be initially located at a first known location and may drift, due to currents and flow of the river, along a drift path 1004. The drift path 1004 may be influenced based at least in part on many factors such as flow velocity, which is influenced by changes in flow volume. Features, such as separations caused by physical objects 1006 may influence drift.

By analyzing drift using test float paths and data collected via the ADP collection devices, the drift path and velocity of a particle and/or object may be predicted. For example, for a river having a given river level, river attributes may be determined for the river including flow velocity at different locations and depths of the river. The particle 1002 or object may have a known buoyancy, which may cause it to travel at the surface of the water, near the bottom of the river, or suspended there between in an intermediate location within the river. The drift module 214 may use flow velocity to determine a possible extent of a drift of the particle, such as by maximizing distance by assuming the particles travels at maximum velocities for each portion of the river for a given depth, minimizing the distance traveled by assuming the particles travels at minimum velocities for each portion of the river for a given depth, or using other variations to arrive at distances between these outcomes. Rather than distance, the drift module 214 may determine a predicted amount of time for a particle to travel a segment of the river or other distance.

The drift module 214 may enable a user to assess the flow path, velocity along the flow path and total drift duration of virtually any particle in the river's hydraulic core. Such a tool may provide valuable information, for example for fisheries biologists to assess the drift of Pallid Sturgeon embryos that drift along the bottom boundary layer of a river channel. Similar analysis could also be completed, as another example, on a river exposed to a train car derailment spilling toxic chemicals or crude oil or crude oil spilled into the river by river scour that breaks a buried pipeline as happened on the Yellowstone River twice in recent years. The drift module 214 may enable prediction of how far crude was carried downstream, where it will disperse and how long it will take to reach various destinations. This tool may enable simulations to be performed to examine scenarios ahead of time for example to prepare for clean-up and evacuation procedures. The drift module 214 can enable the performance of such simulation using real 3D data.

An exemplary system and method for measuring the “drift” of an object in a moving body of water, be it a lake, reservoir or stream, may be implemented, for example using data acquired and processed via the techniques described above with respect to the river analyzer application 206 and associated modules. The system and method, also referred herein as the drift module 214, may provide improved probabilistic forecasts at very small areas of resolution but over wide spatial distances for a wide variety of objects than may have been previously possible using conventional techniques. Drift simulations in accordance with the examples herein may be performed for objects including, but not limited to:
living elements such as a fish egg, embryo, larvae, or fish (such a salmon moving upstream, out migrating juveniles or a salmon carcass floating down); a slice of plant DNA or seed; or an insect, for instance, in the form of a nymph, or adult.
inanimate objects such as, sediment, crude oil, plastic, or fertilizers and pollution also are of tremendous importance to know for purposes ranging from clean up to understanding where they are impacting the impact of plants, animals, soils, and water quality.

In accordance with the present disclosure, a method of simulating drift of an object, which is built upon real measures of flow rather than modeled flow, may be implemented. The method and system herein may substantially expand the spatial scale over which drift simulation can be simulated and may thereby decrease or substantially eliminate the errors in existing methods for simulating drift which typically employ second order model estimates made from first order flow estimates. In accordance with the examples here, measures of real 3D water flow along the entire course of the drift simulation and vertically throughout the water column may be used to improve the simulation results. Drift simulations of the present disclosure may allow for prediction of drift of any object that enters flowing water such as a river or stream based at least in part on the measured characteristics of the water flow and the critical elements of the object.

One advantage of the present disclosure may be to allow fish biologists, dam operators, and managers of the flowing water to determine whether the conditions of the water are conducive to reproduction of fish, insects and other animals that spend time in the water. Another advantage may be to allow assessment of habitat abundance and spatial distribution as a function of flow and changes to flow. For example, a user may run multiple predictions on drift to determine how changing the flow will impact that ability to reproduce under different flow conditions, as well as potential juvenile rearing success including impacts from predication based at least in part on the fact that all aquatic organisms must live and grow and reproduce in the same array of freshwater habitat.

Another advantage may be the ability to predict the movement of species up and down water flows such as salmon who move upstream to spawn and then float down after they have spawned and died, including the success of juveniles that then smolt and migrate downstream to the ocean.

As further examples, predictions of the spread of invasive species in flowing water may also be predicted in accordance with the examples herein. Furthermore, the spread of pollutants including fertilizers, untreated water, hazardous chemicals, and oil, gas, and crude may be predicted, which may allow for much more focused clean-up efforts.

The drift module 214 may calculate what water flow may cause the embryo to be forced to the top. In some examples, an initial assumption of a drift simulation may be that an embryo will remain at the bottom 50 centimeters of the river. This and other assumptions of the simulation may be refined based at least in part on additional modeled and/or actual data (e.g., measure, historical and/or research data). In further examples, the system may be configured to take into effect temperature and temperature changes. Living organism such as fish, there embryos and juveniles may be affected by temperature changes. In warmer water, for example, Sturgeon embryos may develop quicker and achiever greater mobility (i.e., learn to swim) as they develop, along with turning into larvae much quicker and consequently burrow into sand. These changes and effects may be statistically modeled for inclusion into the functionality of the drift module 214. Examples of the drift module 214 may allow for predicting the drift of an object or objects down a flowing water channel. Drifter may use the measurement of water flow and bathometry as previously described.

The disclosure further uses information about the object that influence how it will drift. The information about the object may include:
Specific Gravity: The specific gravity of an object influences how the object interacts with water. If the object's specific gravity is greater than 1.00, then it will tend to drop towards the bottom. If it is less than 1.00, it will tend to stay on the surface or rise to the surface. Pallid sturgeon embryos, for instance, tend to have a specific gravity of between 1.02 and 1.06. At this level, the embryos will tend to move towards the bottom of the water channel, but will remain in suspension in the water column due to the impact of water flow. Crude oil can have both a lower and higher specific gravity. Hence an oil spill can have some portions float while heavier portions sink to the bottom forming “tar-balls” as sand adheres to the crude. Both would have different dispersion patterns and depositional zones requiring different containment and clean-up strategies. Surface Chemistry and Adhesiveness: The tendency of an object to chemically react with other objects or to adhere to them influences float patterns. Calcium ions, for instance, can chemically bind to certain kinds of phosphate and continue to float in the water.
Solubility: Some solids dissolve in water. Sodium chloride, commonly referred to table salt, easily dissolves in water and stays in solution unless it reaches still water when it will drop to the bottom. Other chemicals do not easily dissolve and only move along the bottom of a water channel, rolling along like a piece of gravel or sand.
Swimming Tendencies: Fish, insects, and other animals that live-in water generally can swim. The ability to swim coupled with complex flow paths allows of wide dispersion of organisms in a river and thereby increases the chance of species survival. The drift module results can then be used to assess and direct river restoration activities aimed at increasing available aquatic habitat for all life-cycle stages from spawning and juvenile rearing habitats to resting pools for migrating adult fish.

The disclosure may also use information about water temperature. Water temperature has at least three implications. The first is that water temperature changes the specific gravity of water. At four degrees Celsius, the specific gravity is 1.00. As water temperatures rise, the water molecules separate further apart and the specific gravity gets lower. This change has effects on whether an object floats upward or downward, and the rate at which they do this.

The second effect is that water temperature changes the growth patterns of young fish and insects. Pallid sturgeon embryos, for instance, develop significantly faster. The embryo's swimming ability increases and they reach the larvae stage quicker. At the point a pallid sturgeon embryo reaches the larvae stage; it will seek a sandbar that it can dig into, stopping it from further movement down the water channel. These kinds of effects are common in both young fish and insects.

The third effect is that water temperature may change chemical compounds. Crude oil that is released into very cold water tends to form clumps, whereas in warm water it separates and forms what is commonly called “slicks.”

In various embodiments, the drift module 214 may generate a model and/or generate predictions of movement of objects and/or particles based at least in part on the above information as inputs and/or parameters for the prediction.

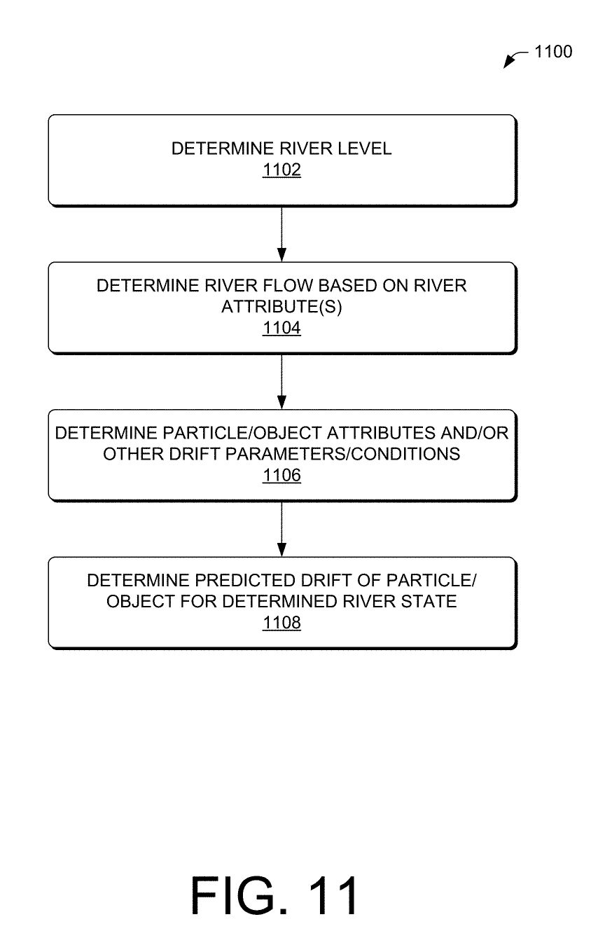

FIG. 11 is a flow diagram of an illustrative process 1100 to predict drift of a particle or object down a section of a river for a given volume of flow. The process 1100 is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. The process 1100 is described with reference to the environment 100 and the computing architecture 200. Of course, the process 1100 may be performed in other similar and/or different environments.

At 1102, the river analyzer application 206 may determine a river level to use as input to determine river attributes. The river level may be determined by physical measurements of the river (e.g., float a GPS enable device on a surface of the water), using LIDAR measurements, and/or other measurements of the surface level. In some embodiments, the river level may be determined based at least in part on a location of the river banks when the river bank profile is well known or measurable.

At 1104, the river attributes and flow characteristics may be determined, such as using a model from the flow stack module 210, for the river level determined at the operation 1102. For example, the river attributes may include flow velocity at different depths and locations in the river, such as in locations as close as few feet apart or possibly closer. However, less granular data may be used. These data points may be enhanced by extrapolating data using algorithms to predict intermediate data points.

At 1106, the drift module 208 may determine particle or object attributes, such as the attributes listed above including specific gravity, ability to swim, etc. At 1106, other parameters and/or conditions may be input to the drift module 214 that may impact calculation of drift. For example, the drift module 214 may include parameters to predict distance of travel for a given time, amount of time to travel a distance, maximum and minimum flow velocity assumptions, and/or other parameters and/or conditions. An example condition may be an ability to swim upstream at a given rate. Other examples of parameters may be mixing of depths of travel by the particle or object during the drift. For example, the particle or object may be suspended at different depths in the river, which may be associated with different flow velocities. The drive module 214 may hold the particle to a certain depth or modify the depth based at least in part on factors such as the bathymetry of the river, for example.

At 1108, the drift module 214 may determine a predicted drift of the particle and/or object for the determined river attributes and particle/object attributes using the parameters and/or conditions imposed on the prediction. The drift module 214, for example may determine a maximum possible travel by applying a maximization function to determine a possible route of drift that encounters maximum flow velocities for the river level which may complies with physical constraints (e.g., object must pass through adjacent locations and must continue movement downstream, for example). Similar predictions may be performed to minimize distance using a minimization algorithm. Time based calculations may be generated to predict time to travel a certain distance, such as a segment of a river. The time predictions may include minimum times and maximum times by applying corresponding algorithms.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
accessing first Acoustic Doppler current Profiler (ADP) data representing a first plurality of float paths down a section of a river during a first river condition, a second plurality of float paths down the section of the river during a second river condition, and a third plurality of float paths down the section of the river during a third river condition that is between the first river condition and the second river condition;
determining, based at least in part on the first ADP data, first river attributes including at least depth and flow rate information within the section of the river;
determining, based at least in part on the second ADP data, second river attributes including at least depth and flow rate information within the section of the river;
determining, based at least in part on the third ADP data, third river attributes including at least depth and flow rate information within the section of the river;
generating a model to predict river attributes at different river conditions between the first river condition and the second river condition, the model generated based at least in part on the first river attributes, the second river attributes, and the third river attributes; and
determining, using the model, fourth river attributes of the river based at least in part on a fourth river condition that is between the first river condition and the second river condition, the model of the fourth river attributes including at least predicted flow rate information within the section of the river.

2. The method as recited in claim 1, wherein the first river condition is a flood condition and the second river condition is a low river condition.

3. The method as recited in claim 1, wherein the model is generated at least partly using regression analysis techniques.

4. The method as recited in claim 1, further comprising:
accessing LIDAR data corresponding to the section of the river, and
combining the LIDAR data with at least some of first ADP data, the second ADP data, or the third ADP data to inform determination of at least some of the first river attributes, the second river attributes, or the third river attributes.

5. The method as recited in claim 4, further comprising outputting a three-dimensional visual representation of the section of the river that includes at least topography and river banks determined using the LIDAR data and visual representations depicting at least some of the fourth river attributes.

6. The method as recited in claim 1, further comprising determining a predicted drift rate of a particle traveling through the section of the river and exposed to the fourth river attributes.

7. The method as recited in claim 1, wherein the fourth river condition is input by at least one of LIDAR data or a planned manmade discharge rate that increases an amount of water in the section of the river.

8. A method of simulating drift of a particle, comprising:
retrieving, using a drift module, volume data of a river section, wherein the volume data comprises three-dimensional (3D) data compiled from river measurements of the river section combined with at least one of LIDAR or satellite data of the river section, and wherein the volume data comprises flow velocity information of the river section segmented into a plurality of flow slices along at least one of a longitudinal, a lateral, or a depth direction;
defining, using the drift module, a plurality of particle variables including a specific buoyancy of the particle, and motility of the particle;
receiving an indication of initial parameters including an initial location of the particle and a drift duration; and
calculating, using the drift module, a change in position of the particle based, in part, on the initial parameters, the particle variables, and the flow velocity information of the river section.

9. The method as recited in claim 8, further comprising generating a visual representation of the change in position of the particle, the visual representation comprising a map of the river section and a predicted path of the particle.

10. The method as recited in claim 8, further comprising determining drift flow velocities of the particle at different locations along the path.

11. The method as recited in claim 8, further comprising generating a visual representation of the change in position of the particle, the visual representation comprising a map of the river section and a predicted path of the particle, and wherein the visual representation includes color-coded information to depict at least one of a flow velocity at different locations in the river or a depth at the different locations in the river.

12. The method as recited in claim 8, further comprising receiving temperature data including water temperature at a location along the river section, a change of water temperature over the drift duration, or a combination thereof, and wherein the calculating is further based at least in part on the temperature data.

13. The method as recited in claim 8, further comprising constructing a database of observed water flow from Acoustic Doppler current Profiler (ADP) data obtained by floating vessels down the river section.

14. A method comprising:
accessing observed river data generated by an Acoustic Doppler current Profiler (ADP) and collected along a plurality of float paths down a section of a river;
generating extrapolated river data based at least in part on the observed river data, the extrapolated river data generating data points at least at locations different than the observed river data;
determining, based at least in part on the observed river data and the extrapolated river data, river attributes including at least depth and flow rate information within the section of the river; and
outputting at least some of the river attributes as visual data to visually depict the river attributes.

15. The method as recited in claim 14, wherein the observed river data includes Global Positioning System (GPS) location information, and wherein the extrapolated river data includes location information for intermediate locations relative to the GPS location information.

16. The method as recited in claim 14, further comprising:
capturing a first portion of the observed river data;
analyzing the first portion of the ADP data, and
generating an instruction to return upstream to capture additional data to add to the observed river data.

17. The method as recited in claim 14, further comprising accessing LIDAR data to determine at least one of a surface of the river or locations of river banks of the river.

18. The method as recited in claim 14, further comprising generating a visualization that includes the visual data to depict a habitat of an aquatic species based at least in part on the river attributes.

19. The method as recited in claim 14, further comprising predicting a drift of a particle or object based at least in part on the river attributes including at least flow velocity at locations along the section of the river.

20. The method as recited in claim 14, wherein the river attributes include at least two of channel size, depth, morphology, flow variance from fast to slow regions, water gains and losses, water temperature, or water clarity.
